(19) United States
(12) Patent Application Publication
(10) Pub. No.: US 2012/0229375 A1
(43) Pub. Date: Sep. 13, 2012

(54) DISPLAY DEVICE, DISPLAY METHOD AND RECORDING MEDIUM

(75) Inventor: Takeshi TANI, Osaka-shi (JP)

(73) Assignee: SHARP KABUSHIKI KAISHA, Osaka (JP)

(21) Appl. No.: 13/416,715

(22) Filed: Mar. 9, 2012

(30) Foreign Application Priority Data
Mar. 10, 2011 (JP) 2011-053475

(51) Int. Cl. G06F 3/01

(52) U.S. Cl. 345/156

(57) ABSTRACT

For a book data display device of the present invention, the user performs an operation similar to an action performed on a real book when searching for a supplement held between pages of the book. At this time, in the book data display device of the present invention, a movement detection section detects the movement of the display device, and a display control section displays the image of a supplement in a display section on the basis of the detection result of the movement detection section.

### CROSS-REFERENCE TO RELATED APPLICATION

This non-provisional application claims priority under 35 U.S.C. §119(a) on Patent Application No. 2011-53475 filed in Japan on Mar. 10, 2011, the entire contents of which are hereby incorporated by reference.

### BACKGROUND

1. Technical Field

The present invention relates to a display device, a display method, and a recording medium storing a computer program for displaying additional information for a given content when displaying the content.

2. Description of Related Art

In recent years, a variety of mobile information terminal devices capable of playing digital content have been popular. Among them, particularly mobile information terminal devices which enable us to install so-called electronic books and enjoy reading anywhere, anytime are becoming widespread.

For example, Japanese Patent Application Laid-Open No. 2000-163193 discloses a mobile information equipment with a touch panel on the display screen, which lets user to turn pages of images sequentially as if turning pages of a real book by touching with user's finger the image of the page displayed on the display screen and sliding the finger in a turning direction, or lets user to move directly to a specific page by touching a desired tab.

Japanese Patent Application Laid-Open No. 2003-163742 discloses a mobile terminal device which includes an acceleration sensor detects acceleration of vibration etc. being applied to the device, measures the duration of acceleration being applied, and receives a given instruction.

Further, Japanese Patent Application Laid-Open. No. 2010-252201 discloses a mobile terminal device which has a communication function, such as a telephone function and a mailing function, and an orientation sensor for detecting the orientation of the mobile terminal device, or an acceleration sensor, receives a given instruction according to the orientation of the mobile terminal device and the speed of change of the orientation, and gives a voice-guide about the content of the received instruction.

### SUMMARY

However, in terms of a reproduction of a real book, the above-mentioned conventional mobile information terminal devices are not sufficient and often require the users to perform different operations from those for real books in using the information terminal devices, and therefore the users who are accustomed to real books may have a strange feeling.

For instance, when a reader has a real book and wants to drop a coupon, a discount ticket etc. held between pages of the book, the reader performs the action of shaking the book sideways or a downward direction. However, none of the subject matters of Japanese Patent Application Laid-Open No. 2000-163193, 2003-163742 and 2010-252201 considers the imitation of such an action of the user (reader).

The subject matters of Japanese Patent Application Laid-Open No. 2003-163742 and 2010-252201 mention the configuration of receiving a given instruction when the user performs the action of shaking the terminal device, but they just use the user's “shaking” action as a single instruction operation and do not devise effective measures for the reproduction of a real book or the imitation of the user's (reader's) action as mentioned above.

The present invention has been made with the aim of solving the above problems, and it is an object of the present invention to provide a display device capable of obtaining effects similar to those on a real book by performing an operation similar to an action of a user performed on a real book by detecting the movement of the display device with a movement detection section when displaying content with additional information in a display section and displaying additional information for content, such as, for example, a supplement, in the display section on the basis of the detection result of the movement detection section by a display control section, and thereby capable of being operated in a manner more similar to handling a real book, and capable of being operated intuitively without causing a strange feeling to the user who is accustomed to real books, and to provide a display method and a recording medium storing a computer program for the display device.

The display device according to the present invention is a display device, including a storage section storing content with additional information, and a display section for displaying an image relating to the content, the display device comprising: a movement detection section for detecting a movement of the display device; and a display control section for displaying the additional information in the display section on the basis of a detection result of the movement detection section.

According to the invention, the movement detection section detects the movement of the display device, and the display control section displays the additional information in the display section on the basis of the detection result of the movement detection section.

The display device according to the present invention is characterized by further comprising a posture detection section for detecting a posture of the display device, wherein the display control section displays the additional information on the basis of detection results of the movement detection section and the posture detection section.

According to the invention, the posture detection section detects the posture of the display device, and the movement detection section detects the movement of the display device. The display control section displays the additional information on the basis of the detection results of the movement detection section and the posture detection section.

The display device according to the present invention is characterized in that the storage section stores a plurality of pieces of additional information, display conditions for each piece of additional information, and user information, the display device further comprises a selection section for selecting a given piece of additional information on the basis of the display conditions for additional information and the user information, and the display control section displays the additional information selected by the selection section.

According to the invention, the storage section stores a plurality of pieces of additional information, display conditions for each piece of additional information, and user information. The selection section selects a given piece of additional information on the basis of the display conditions for additional information and user information. The display control section displays the additional information selected by the selection section in the display section.

The display device according to the present invention is characterized in that the content is composed of a plurality of pages of images, the storage section stores additional information in association with a specific page of the content, and when the specific page is displayed in the display section, the display control section displays the corresponding additional information.

According to the invention, the storage section stores the additional information in association with a specific page of the content, and, only when the specific page is displayed in the display section, the display control section displays the corresponding additional information.

A display method according to the present invention is a display method for displaying additional information with a display device, which includes a storage section storing content with additional information, a display section for displaying an image relating to the content, a movement detection section for detecting a movement of the display device, and a posture detection section for detecting a posture of the display device, the method comprising: a step of detecting the movement and posture of the display device by the movement detection section and the posture detection section; and a step of displaying the additional information in the display section on the basis of detection results of the movement detection section and the posture detection section.

The recording medium according to the present invention is a non-transitory computer-readable recording medium in which a computer program for causing a computer constituting a display device, which includes a storage section storing content with additional information, a display section for displaying an image relating to the content, a movement detection section for detecting a movement of the display device, and a posture detection section for detecting a posture of the display device, to display the additional information, said computer program comprising: a step of causing the computer to perform detection of the movement and posture of the display device with the movement detection section and the posture detection section; and a step of causing the computer to display the additional information in the display section on the basis of detection results of the movement detection section and the posture detection section.

According to the invention, the posture detection section detects the posture of the display device, and the movement detection section detects the movement of the display device. The additional information is displayed in the display section on the basis of such detection results of the movement detection section and the posture detection section.

According to the invention, the above-mentioned computer program is recorded in the recording medium. A computer retrieves the computer program from the recording medium, and the above-mentioned display device and display method are realized by the computer. According to the invention, with an operation similar to action performed by the user on a real book, an effect similar to that on the real book is obtained, and it is possible to handle the display device in a manner similar to a real book and allow the user who is accustomed to real books to handle the display device intuitively without a strange feeling, thereby providing improved handling performance for the user.

The above and further objects and features will more fully be apparent from the following detailed description with accompanying drawings.

### BRIEF DESCRIPTION OF THE SEVERAL VIEWS OF THE DRAWINGS

FIG. 1 is a functional block diagram illustrating an essential configuration of a book data display device of Embodiment 1 of the present invention.

FIG. 2 is a conceptual view illustrating conceptually the stored content in a user information storage section of the book data display device of Embodiment 1 of the present invention.

FIG. 3 is a conceptual view illustrating conceptually an. information management table in the book data display device of Embodiment 1 of the present invention.

FIG. 4 is a functional block diagram illustrating an essential configuration of a detection section of the book data display device of Embodiment 1 of the present invention.

FIG. 5 is a flowchart for explaining the process of displaying a supplement in the book data display device of Embodiment 1 of the present invention.

FIG. 6 is an exemplary view illustrating an example of an electronic book displayed by the book data display device of Embodiment 1 of the present invention.

FIG. 7 is an exemplary view illustrating an example of a supplement to an electronic book displayed by the book data display device of Embodiment 1 of the present invention.

FIG. 8 is an exemplary view illustrating an example of a supplement to an electronic book displayed by the book data display device of Embodiment 1 of the present invention.

FIG. 9 is a flowchart explaining the process of displaying a supplement in a book data display device of Embodiment 2 of the present invention.

FIG. 10 is an exemplary view illustrating an example of a supplement to an electronic book displayed by the book data display device of Embodiment 2 of the present invention.

FIG. 11 is a flowchart for explaining the process of displaying a supplement in a book data display device of Embodiment 3 of the present invention.

FIG. 12 is an exemplary view illustrating an example of an electronic book displayed by the book data display device of Embodiment 3 of the present invention.

FIG. 13 is an exemplary view illustrating an example of a supplement to an electronic book displayed by the book data display device of Embodiment 3 of the present invention.

FIG. 14 is a functional block diagram illustrating an essential configuration of a book data display device of Embodiment 4 of the present invention.

### DETAILED DESCRIPTION

Referring to the drawings, the following will explain in detail the present invention by way of an example in which a display device, a display method and a computer program according to an embodiment of the present invention are applied to a book data display device having a so-called electronic book function.

### Embodiment 1

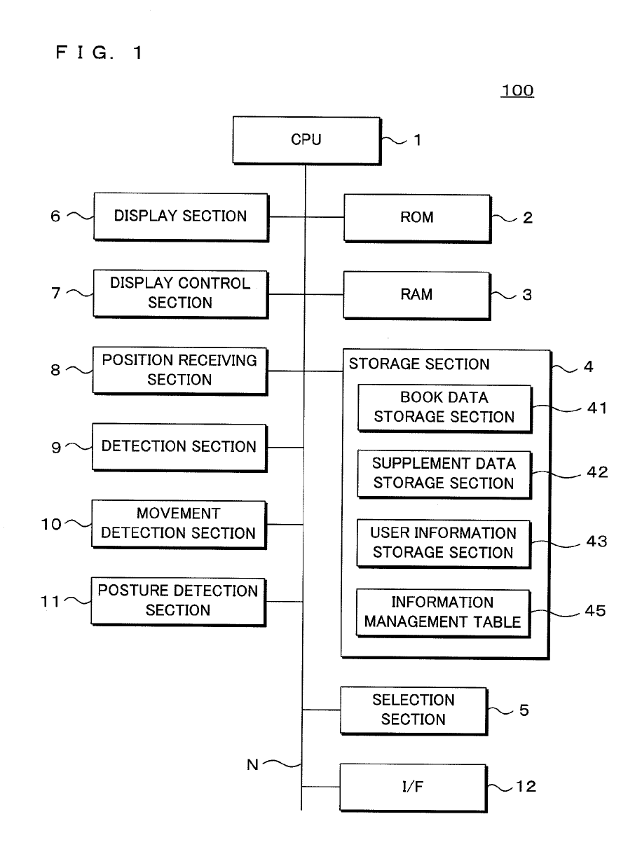

FIG. 1 is a functional block diagram illustrating an essential configuration of a book data display device 100 according to Embodiment 1 of the present invention. The book data display device 100 comprises a CPU 1, a ROM 2, and a RAM 3.

The ROM 2 stores in advance various kinds of control programs, and basically fixed data among parameters for operations, etc. The RAM 3 temporarily stores data and allows retrieval of data irrespective of the stored order, stored location etc. For example, the RAM 3 stores a program retrieved from the ROM 2, various kinds of data generated by the execution of the program, and parameters which vary suitably when executing the program.

The CPU 1 controls the following various hardware devices through a bus N by loading a control program stored in advance in the ROM 2 onto the RAM 3 and executing the program, and enables the whole devices to operate as the book data display device 100 of the present invention. Moreover, the CPU 1 receives an input of a processing instruction from a user through a later-described position receiving section 8.

The book data display device 100 according to Embodiment 1 of the present invention further comprises a storage section 4, a selection section 5, a display section 6, a display control section 7, the position receiving section 8, a detection section 9, a movement detection section 10, a posture detection section 11, and I/F (Interface) 12.

The storage section 4 is composed of a non-volatile storage medium, such as, for example, a flash memory, an EEPROM, an HDD, an MRAM (magnetoresistive random access memory), an FeRAM (ferroelectric random access memory), or an OUM. The storage section 4 includes a book data storage section 41, a supplement data storage section 42, and a user information storage section 43.

The book data storage section 41 stores a plurality of pieces of book data. The book data is content data of an electronic book consisting of a plurality of pages of images. The display control section 7 displays a given page of the electronic book in the display section 6 on the basis of the book data.

The supplement data storage section 42 stores data relating to supplements (additional information) belonging to the book data stored in the book data storage section 41. For example, the supplement data storage section 42 stores image data for displaying coupons, discount tickets etc. as supplements to the electronic book (hereinafter referred to as “supplement image data”). Namely, image data relating to later-described “Supplement 1A”, “Supplement 2A”, “Supplement 2B” etc. are stored.

The user information storage section 43 stores information about a user (owner) of the book data display device 100. The owner of the book data display device 100 inputs information about himself/herself by appropriately manipulating the book data display device 100. The information inputted by the user (hereinafter referred to as the user information) is stored in the user information storage section 43.

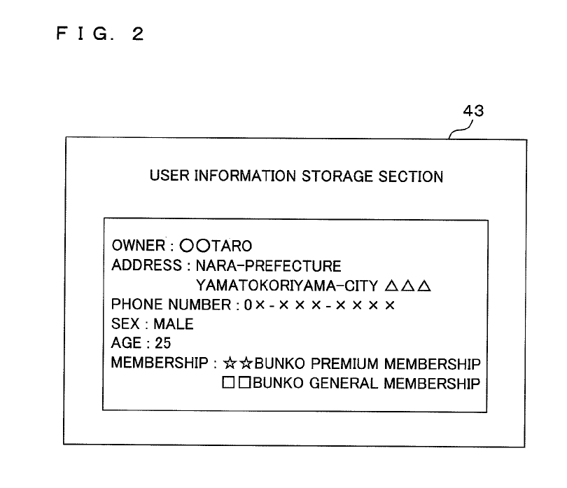

FIG. 2 is a conceptual view illustrating conceptually the stored content in the user information storage section 43 of the book data display device 100 according to Embodiment 1 of the present invention. As illustrated in FIG. 2, the user information storage section 43 stores, for example, the owner's name, address, telephone number, sex, age etc. Moreover, the user information storage section 43 stores the company name of a company providing the electronic book for which the user has a membership, the membership category etc.

The storage section 4 also stores information management table 45. The information management table 45 is for managing supplements to each piece of the book data stored in the book data storage section 41 of the storage section 4. The supplements are displayed on the basis of the information management table 45.

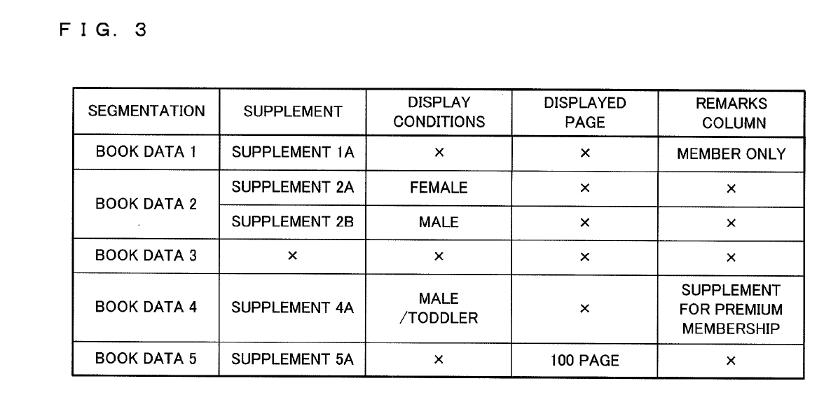

FIG. 3 is a conceptual view illustrating conceptually the information management table 45 of the book data display device 100 according to Embodiment 1 of the present invention. In the information management table 45 illustrated in FIG. 3, the details of the book data stored in the book data storage section 41, whether or not there is a supplement to each piece of book data, display conditions for supplements, a displayed page of a supplement etc. are written.

The display conditions for a supplement are conditions required for the user when displaying the supplement. A displayed page of the supplement is a page (number) requested to be displayed in the display section 6 when displaying the supplement. Such information is given by a company providing an electronic book.

More specifically, the information management table 45 indicates that Book Data 1 has “Supplement 1A” as a supplement, and the supplement is provided only to “Members”. For Book Data 2, it is written that there are two supplements, namely, “Supplement 2A” and “Supplement 2B”, and that “Supplement 2A” is provided to female users, while “Supplement 2B” is provided to male users. For Book Data 3, it is written that there is no supplement. For Book Data 4, it is written that there is “Supplement 4A” which is targeted for toddler boys and that there is an additional supplement for premium members. For Book Data 5, it is written that there is “Supplement 5A” and that the supplement is to be displayed only when “page 100” of the electronic book is displayed.

The data relating to the electronic book and supplements are downloaded from an external communication network through the I/F 12, or retrieved from a record stored in a removable recording medium, not shown, and stored in the storage section 4 as described above.

The selection section 5 selects any of the supplements (supplement data), according to an instruction from the CPU 1. More specifically, the selection section 5 selects, on the basis of the information management table 45, a supplement corresponding to an electronic book (book data) selected by the user. If there is a plurality of supplements corresponding to the electronic book selected by the user, any of the supplements is selected on the basis of the display conditions in the information management table 45 and the user information in the user information storage section 43.

The display section 6 is composed, for example, of an LCD or EL (Electroluminescence) panel and displays the content of an electronic book. The display screen of the display section 6 is covered with the position receiving section 8.

The display control section 7 is composed of a processor, such as a DSP (Digital Signal Processor), and controls the display of an image in the display section 6. For example, image data of an image to be displayed in the display section 6 is generated according to an instruction from the CPU 1. More specifically, the display control section 7 generates image data about the content of the electronic book to be displayed in the display section 6 on the basis of the book data, and displays an image based on the generated image data (the content of the electronic book) in the display section 6.

Moreover, the display control section 7 implements an animation display in which the images of pages of the electronic book displayed in the display section 6 are turned in page order, or reverse page order, thereby implementing page-turning display which realizes page turning of a real book in a pseudo manner. The page-turning display is a known art for producing a visual effect of turning pages of a book one page at a time. For example, in the case where the display section 6 displays the electronic book in a fully opened state, when the user touches the left page and drugs his/her finger, an animation in which the page is turned in reverse page order is displayed, whereas when the user touches the right page and drugs the finger, an animation, in which the page is turned in page order is displayed.

The position receiving section 8 includes a so-called touch panel arranged to cover the display screen of the display section 6. The position receiving section 8 receives a position specification on the display screen of the display section 6 by a touch operation of the user. In other words, the position receiving section 8 detects a change of pressure caused by the touch operation of the user's fingertip, or detects an electric signal caused by static electricity, and detects coordinates on the display screen of the display section 6 corresponding to the contact point of the user's fingertip, and generates a signal specifying the coordinates. The position receiving section 8 is not limited to this, and may be configured with a pointing device (for example, a stylus pen).

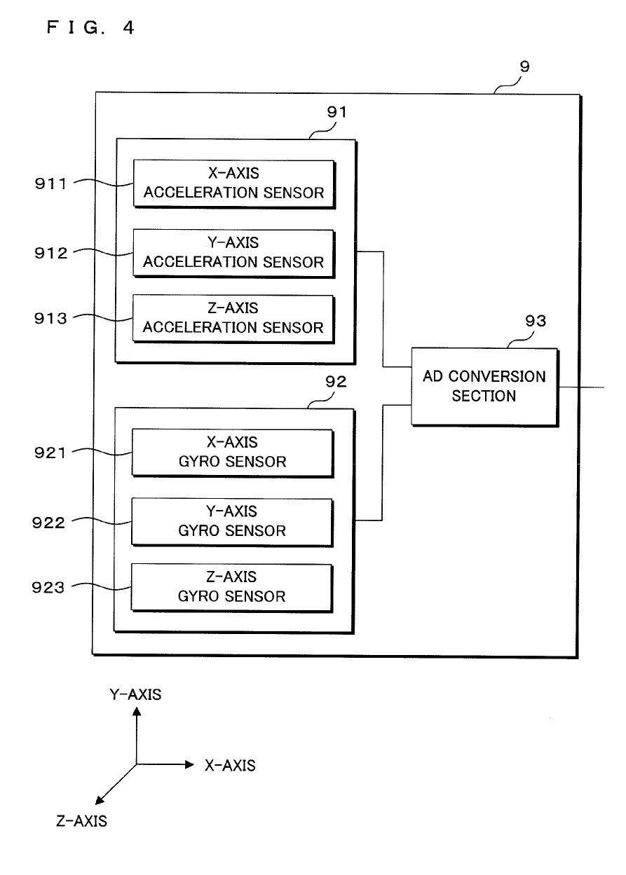

The detection section 9 is, for example, an MEMS acceleration sensor, an MEMS gyro sensor etc. and detects the movement and posture of the book data display device 100. FIG. 4 is a functional block diagram illustrating an essential configuration of the detection section 9 of the book data display device 100 according to Embodiment 1 of the present invention. The detection section 9 comprises an acceleration sensor 91 for detecting gravity and acceleration in a plurality of directions, and a gyro sensor 92 for detecting angular velocities in a plurality of directions.

As illustrated in FIG. 4, the acceleration sensor 91 includes an X-axis acceleration sensor 911, a Y-axis acceleration sensor 912, and a Z-axis acceleration sensor 913 for detecting gravity and acceleration in the X-axis direction, the Y-axis direction, and the Z-axis direction, respectively.

The gyro sensor 92 includes an X-axis gyro sensor 921, a Y-axis gyro sensor 922, and a Z-axis gyro sensor 923 for detecting angular velocities with the X-axis, the Y-axis, and the Z-axis as the rotation axes, which are orthogonal to each other.

Thus, the acceleration sensor 91 is capable of detecting the linear movement of the book data display device 100 in up, down, forward, backward, right and left directions, and the gyro sensor is capable of detecting the rotation movement of the book data display device 100.

The acceleration sensor 91 and the gyro sensor 92 are respectively connected to an AD conversion section 93 so that output signals corresponding to detection results outputted from the gyro sensor 92 and the acceleration sensor 91 are sent to the AD conversion section 93 and converted from analog signals to digital signals. The digital signals are supplied to the CPU 1.

The movement detection section 10 detects the movement of the book data display device 100 in various directions on the basis of the detection results of the acceleration sensor 91 and/or the gyro sensor 92. For example, on the basis of the detection results of the acceleration sensor 91 and/or the gyro sensor 92, the movement detection section 10 determines that a given movement is the “shaking” movement of the book data display device 100 in up and down directions.

On the basis of the detection results of the acceleration sensor 91 and/or the gyro sensor 92, the posture detection section 11 detects which surface of the book data display device 100 is oriented in which direction. In short, it detects the posture of the book data display device 100. For example, the posture detection section 11 determines, based on the detection results of the acceleration sensor 91 and/or the gyro sensor 92, whether the display section 6 of the book data display device 100 faces a downward direction.

The above-mentioned detection results of the movement detection section 10 and the posture detection section 11 are supplied to the CPU 1. Hence, the CPU 1 is capable of determining, based on the detection results of the movement detection section 10 and the posture detection section 11, whether or not the book data display device 100 was shaken in the up and down directions and whether or not the display section 6 faces a downward direction.

When the CPU 1 determines that the display section 6 faces a downward direction and that the book data display device 100 was shaken in the upward and downward directions, it instructs the display control section 7 to display a supplement relating to the electronic book being displayed.

In short, with the operation similar to the user's action (operation) of “shaking” a real book to drop supplements, such as a coupon and a discount ticket, held between pages of the book, an effect similar to that on the real book is obtained. It is thus possible to provide improved handling performance for the user, without giving an strange feeling to even a user who is accustomed to real books.

The following will explain in detail a supplement display process to be performed in the book data display device 100 according to Embodiment 1 of the present invention.

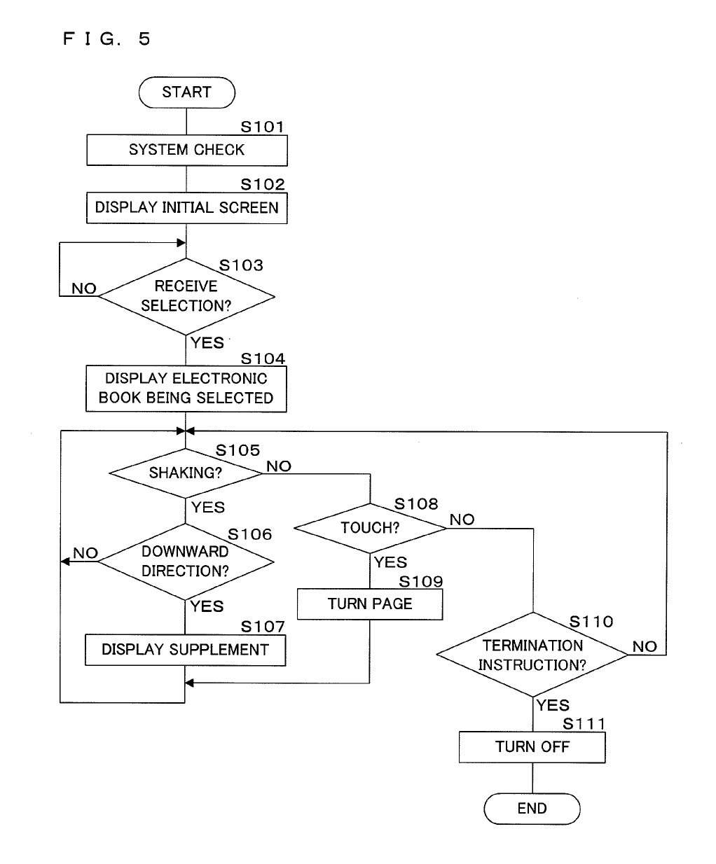

FIG. 5 is a flowchart illustrating the process of displaying a supplement in the book data display device 100 of Embodiment 1 of the present invention. For the sake of explanation, suppose that the user performs either the operation of shaking the book data display device 100 or the operation of touching the display screen of the display section 6. The explanation is given with reference to the information management table 45 illustrated in FIG. 3.

When the user turns on the power switch (not shown) of the book data display device 100, a system check is performed (step S101). If there is no problem, an electronic book selection screen is displayed as an initial screen (step S102).

For example, the user selects a desired electronic book from a plurality of electronic books displayed in the selection screen by touching the display screen of the display section 6. With this user's touch operation, the CPU 1 receives the selection of any of the electronic books through the position receiving section 8.

The CPU 1 determines, based on a signal from the position receiving section 8, whether or not the selection of any of the electronic books was received (step S103). If determined that the selection of any of the electronic books was not received (S103: NO), the CPU 1 repeats the determination process until it receives the selection of any of the electronic books.

If determined that the selection of any of the electronic books was received (S103: YES), the CPU 1 instructs the display control section 7 to display the electronic book corresponding to the received selection. According to the instruction from the CPU 1, the display control section 7 displays the image of the selected electronic book in the display section 6 on the basis of the book data stored in the book data storage section 41 (step S104). Thereafter, the user performs an appropriate operation (for example, a touch operation) and reads the electronic book while displaying a given page of the electronic book.

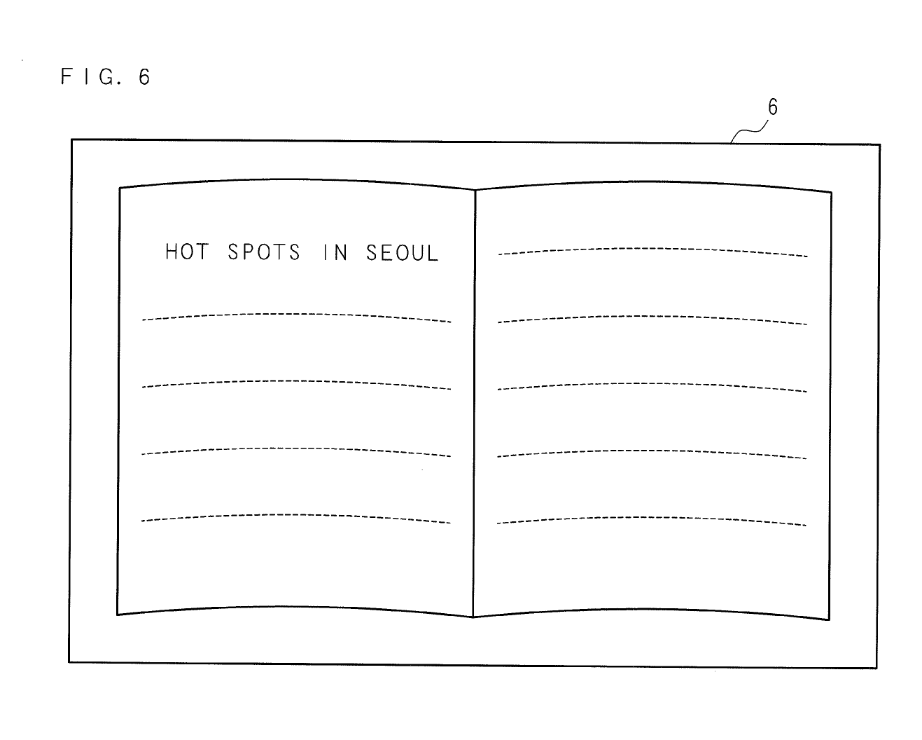

For example, suppose that the user selects an electronic book corresponding to Book Data 2 in the information management table 45 in FIG. 3. This electronic book is “Travel Guide Book”, and the image of given pages of the electronic book is displayed in the display section 6 as illustrated in FIG. 6.

The CPU 1 determines whether or not the operation of shaking the book data display device 100 in up and down directions was performed (step S105) by monitoring the movement detection section 10, or based on the detection result of the movement detection section 10.

If determined that the operation of shaking the book data display device 100 in up and down directions was performed (step S105: YES), the CPU 1 determines, based on the detection result of the posture detection section 11, whether or not the display section 6 faces a downward direction (step S106).

If determined that the display section 6 does not face a downward direction (step S106: NO), the CPU 1 returns the processing to step S105. Or other process corresponding to the shaking operation performed in a state where the display section 6 does not face a downward direction is appropriately performed.

If determined that the display section 6 faces a downward direction (step S106: YES), the CPU 1 instructs the display control section 7 to display a supplement relating to the electronic book being displayed. The selection section 5 selects, on the basis of the information management table 45 in FIG. 3, supplement image data (“Supplement 2A” and “Supplement 2B”) corresponding to the selected electronic book, and the display control section 7 retrieves the supplement image data selected by the selection section 5 from the supplement data storage section 42 and displays the images of the supplements (“Supplement 2A” and “Supplement 2B”) based on the supplement image data in the display section 6 (step S107). Thereafter, the processing returns to step S105 again.

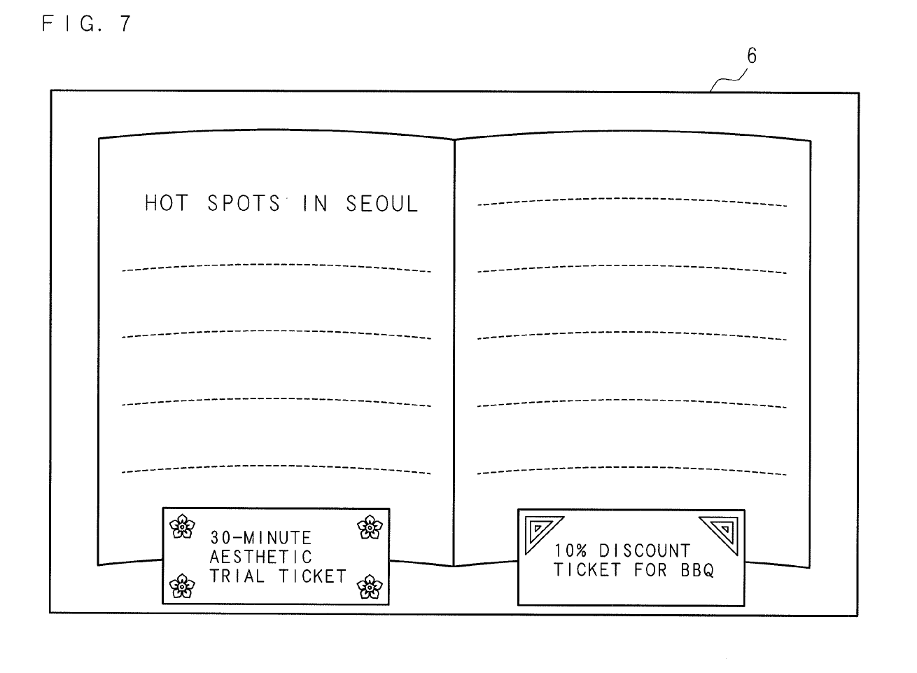

For example, if “Supplement 2A” and “Supplement 2B” are “30-Minute Aesthetic Trial Ticket” and “10% Discount Ticket for BBQ”, respectively, the supplements are displayed in an overlapped manner on the pages being displayed as illustrated in FIG. 7. The user can display the image of any of the supplements in an enlarged manner by touching the image and can show it to the shop.

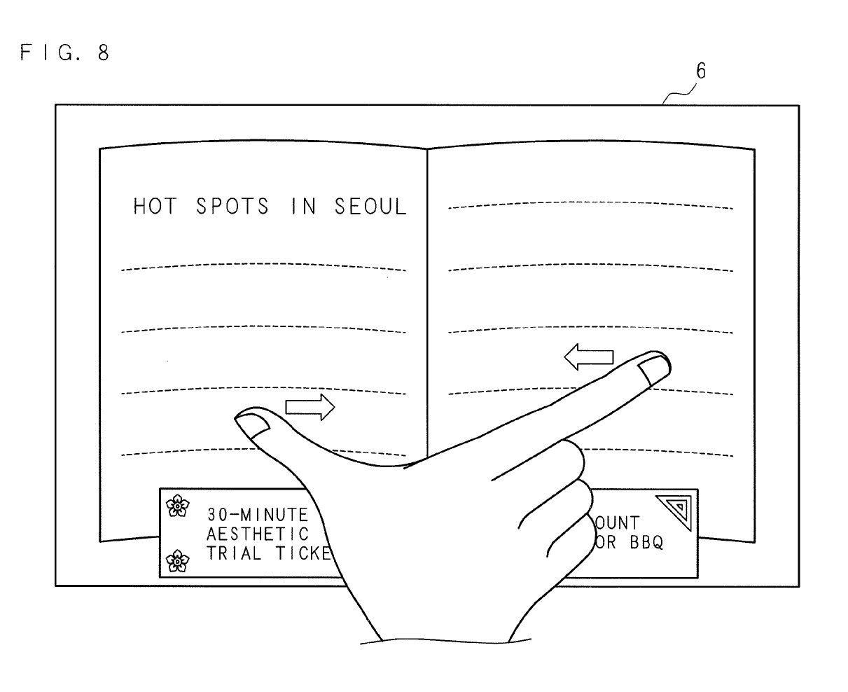

When the showing of the image to the shop is finished, the user touches two points on the display screen of the display section 6 with his/her two fingers as illustrated in FIG. 8, and then drugs the two fingers in directions to narrow the space between the two fingers. In other words, the user performs the operation as if closing a real book, deletes the displayed images of the supplements, and returns to the displayed state illustrated in FIG. 6. Specifically, when the position receiving section 8 received position specifications of two points separated from each other by a given distance or more and the two points moved in directions to narrow the distance between the two points, the CPU 1 instructs the display control section 7 to delete the images of the supplements being displayed.

On the other hand, in step S105, if determined that the operation of shaking the book data display device 100 in up and down directions was not performed (step S105: NO), the CPU 1 monitors the position receiving section 8 and determines, based on a signal from the position receiving section 8, whether or not the user performed the operation of touching the display screen of the display section 6 (step S108).

If determined that the user performed the operation of touching the display screen of the display section 6 (step S108: YES), the CPU 1 instructs the display control section 7 to display an animation of turning pages. According to the instruction of the CPU 1, the display control section 7 displays an animation of turning pages (step S109), and displays the next pages or the previous pages. Thereafter, the processing is returned to step S105 again.

If determined that the user did not perform the operation of touching the display screen of the display section 6 (step S108: NO), the CPU 1 monitors the power switch (not shown) in order to determine whether or not a termination instruction was received (step S110).

If determined that the termination instruction was not received (step S110: NO), the CPU 1 returns the processing to step S105. On the other hand, if determined that the termination instruction was received (step S110: YES), the CPU 1 turns off the power switch (step S111) and terminates the processing.

The above is explained by way of an example in which a supplement is displayed in an overlapped manner on a given page being displayed, but the present invention is not limited to this. For example, the book data display device 100 may be arranged to display the supplement in place of the given page being displayed.

In the case where there is no supplement like for Book Data 3 in the information management table 45 in FIG. 3, the book data display device 100 may be arranged to display a message indicating this fact.

The above is also explained by way of an example in which a plurality of supplements are displayed together, but the present invention is not limited to this. The book data display device 100 may be arranged to display a plurality of supplements sequentially according to the “shaking” operation of the user.

### Embodiment 2

When there is a plurality of supplements relating to a given electronic book, a book data display device 100 of Embodiment 2 of the present invention selectively displays the image of any of the supplements suitable for a user on the basis of the display conditions for the supplements and the user information. In short, the book data display device 100 is capable of displaying the images of different supplements according to the user (owner) of the book data display device 100.

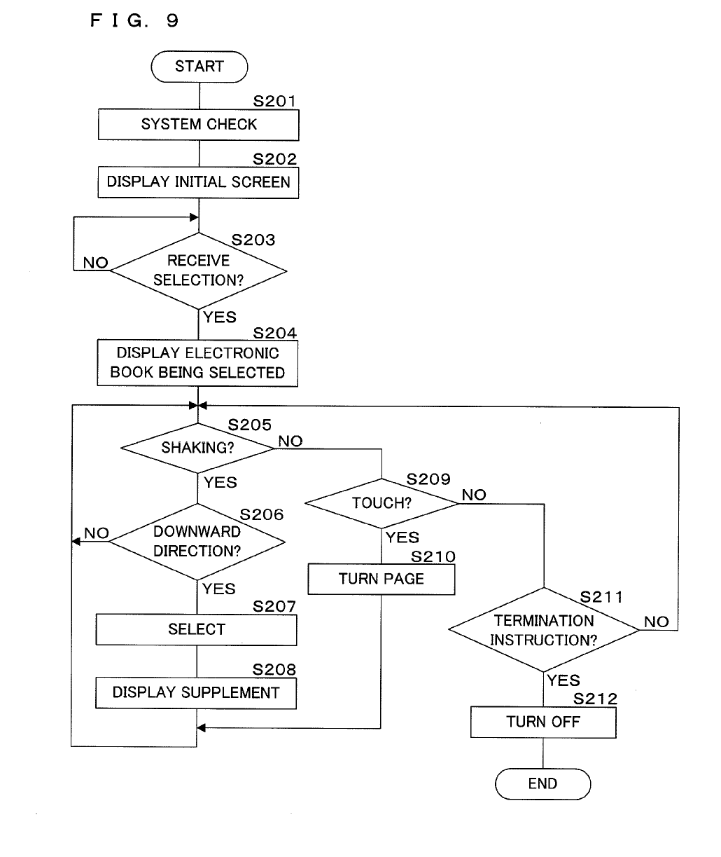

FIG. 9 is a flowchart explaining the process of displaying a supplement in the book data display device 100 according to Embodiment 2 of the present invention. For the sake of explanation, suppose that the user performs either the operation of shaking the book data display device 100 or the operation of touching the display screen of the display section 6. This process is explained with reference to the user information illustrated in FIG. 2 and the information management table 45 in FIG. 3.

When the user turns on the power switch (not shown) of the book data display device 100, a system check is performed (step S201). If there is no problem, the electronic book selection screen is displayed as an initial screen (step S202).

For example, the user selects a desired electronic book by touching the display screen of the display section 6. With this user's touch operation, the CPU 1 receives the selection of any of the electronic books through the position receiving section 8.

The CPU 1 determines, based on a signal from the position receiving section 8, whether or not the selection of any of the electronic books was received (step S203). If determined that the selection of any of the electronic books was not received (S203: NO), the CPU 1 repeats the determination process until it receives the selection of any of the electronic books.

If the CPU 1 determined that the selection of any of the electronic books was received (S203: YES), the display control section 7 displays the image of the selected electronic book in the display section 6 on the basis of the book data stored in the book data storage section 41 (step S204). Thereafter, the user reads the electronic book by displaying given pages of the electronic book with a suitable operation (for example, a touch operation).

For example, suppose that the user selects an electronic book relating to Book Data 2 in the information management table 45 illustrated in FIG. 3. This electronic book is “Travel Guide Book”, and the image of given pages of the electronic book is displayed in the display section 6 as illustrated in FIG. 6. The electronic book has two supplements (“Supplement 2A” and “Supplement 2B”).

By monitoring the movement detection section 10, or based on the detection result of the movement detection section 10, the CPU 1 determines whether or not the operation of shaking the book data display device 100 in up and down directions was performed (step S205).

If determined that the operation of shaking the book data display device 100 in up and down directions was performed (step S205: YES), the CPU 1 determines, based on the detection result of the posture detection section 11, whether or not the display section 6 faces a downward direction (step S206).

If determined that the display section 6 does not face a downward direction (step S206: NO), the CPU 1 returns the processing to step S205. Or other process according to the shaking operation performed in a state where the display section 6 does not face a downward direction is appropriately performed.

If determined that the display section 6 faces a downward direction (step S206: YES), the CPU 1 instructs the display control section 7 to display a supplement relating to the electronic book being displayed.

However, since the selected electronic book has a plurality of supplements (“Supplement 2A” and “Supplement 2B”), the selection section 5 selects any of the supplements on the basis of the user information illustrated in FIG. 2 and the information management table 45 in FIG. 3 (step S207).

More specifically, the selection section 5 compares the display conditions of “Supplement 2A” and the display conditions of “Supplement 2B” on the basis of the information management table 45 illustrated in FIG. 3, and the user information illustrated in FIG. 2. In other words, in the information management table 45, the display condition of “Supplement 2A” indicates that the user is “Female”, whereas the, display condition of “Supplement 2B” indicates that the user is “Male”. Meanwhile, according to the user information, the owner is “Male”. Therefore, the selection section 5 selects “Supplement 2B”, and the CPU 1 instructs the display control section 7 to display the image of “Supplement 2B”.

According to the instruction from the CPU 1, the display control section 7 retrieves supplement image data corresponding to “Supplement 2B” from the supplement data storage section 42, and displays the image of “Supplement 2B” based on the supplement. image data in the display section 6 (step S208). Thereafter, the processing returns to step S205 again.

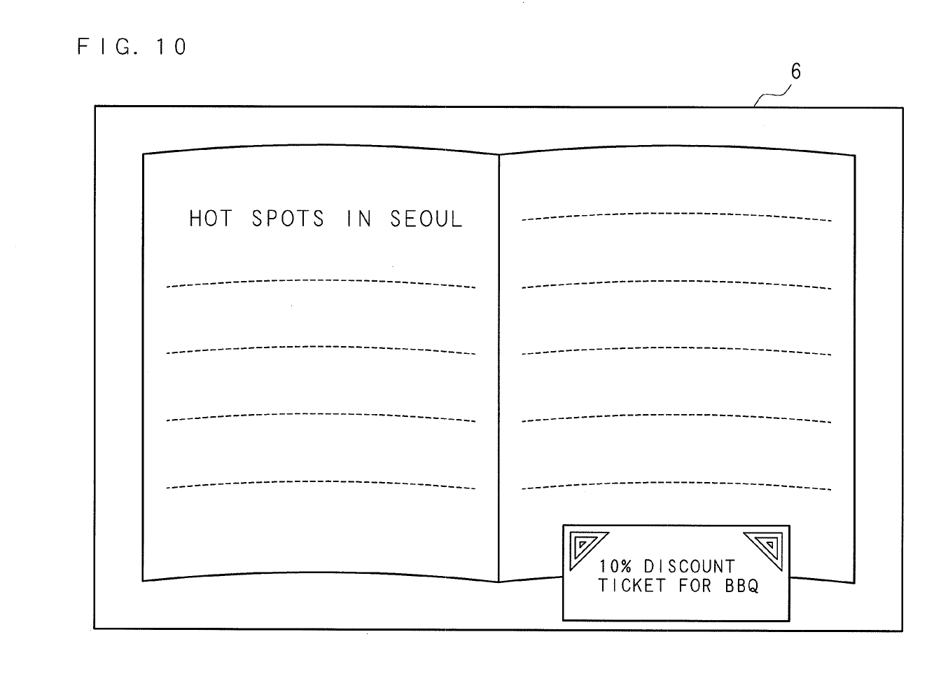

In short, in Embodiment 1 (see FIG. 7), when “Supplement 2A” and “Supplement 2B” are “30-Minute Aesthetic Trial Ticket” and “10% Discount Ticket for BBQ”, respectively, the supplements are displayed in an overlapped manner on the pages being displayed, but, in Embodiment 2, as illustrated in FIG. 10, only the “10% Discount Ticket for BBQ” for “Supplement 2B” which is suitable for the user (owner) of the book data display device 100 of Embodiment 2 is displayed. The user can display the image of the supplement in an enlarged manner by touching the image and can show it to the shop.

On the other hand, if determined in step S205 that the operation of shaking the book data display device 100 in up and down directions was not performed (step S205: NO), the CPU 1 monitors the position receiving section 8, and determines, based on a signal from the position receiving section 8, whether or not the user touched the display screen of the display section 6 (step S209).

The processes in subsequent steps S209 to step S212 are the same as those in steps S108 to step S111 of Embodiment 1, and therefore detailed explanation thereof is omitted.

The same parts as in Embodiment 1 will be designated with the same reference numbers, and detailed explanation thereof is omitted.

### Embodiment 3

A book data display device 100 according to Embodiment 3 of the present invention is arranged so that, when a supplement relating to a given electronic book is to be displayed, the supplement is displayed only when a specific page of the electronic book is displayed in the display section 6. For instance, the supplement is displayed only when a page showing items relating to the supplement is displayed.

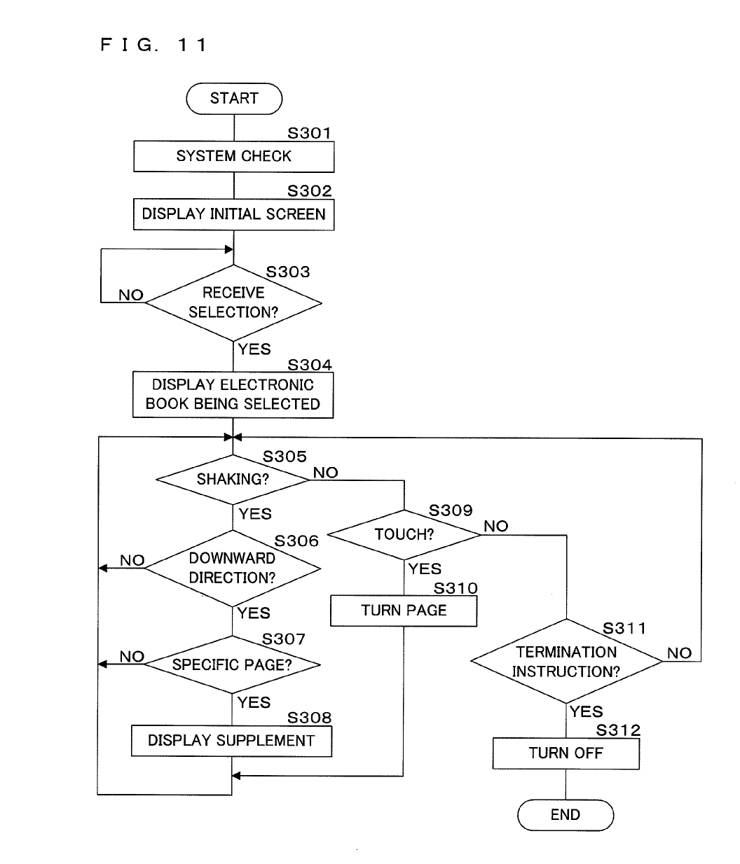

FIG. 11 is a flowchart explaining the process of displaying a supplement in the book data display device 100 according to Embodiment 3 of the present invention. For the sake of explanation, suppose that the user performs either the operation of shaking the book data display device 100 or the operation of touching the display screen of the display section 6. This process is explained with reference to the information management table 45 illustrated in FIG. 3.

When the user turns on the power switch (not shown) of the book data display device 100, a system check is performed (step S301). If there is no problem, the electronic book selection screen is displayed as an initial screen (step S302).

For example, the user selects any desired electronic book by touching the display screen of the display section 6. With this user's touch operation, the CPU 1 receives the selection of any of the electronic books through the position receiving section 8.

The CPU 1 determines, based on a signal from the position receiving section 8, whether or not the selection of any of the electronic books was received (step S303). If determined that the selection of any of the electronic books was not received (S303: NO), the CPU 1 repeats the determination process until it receives the selection of any of the electronic books.

If the CPU 1 determined that the selection of any of the electronic books was received (S303: YES), the display control section 7 displays the image of the selected electronic book in the display section 6 on the basis of the book data stored in the book data storage section 41 (step S304). Thereafter, the user reads the electronic book by displaying given pages of the electronic book with a suitable operation (for example, a touch operation).

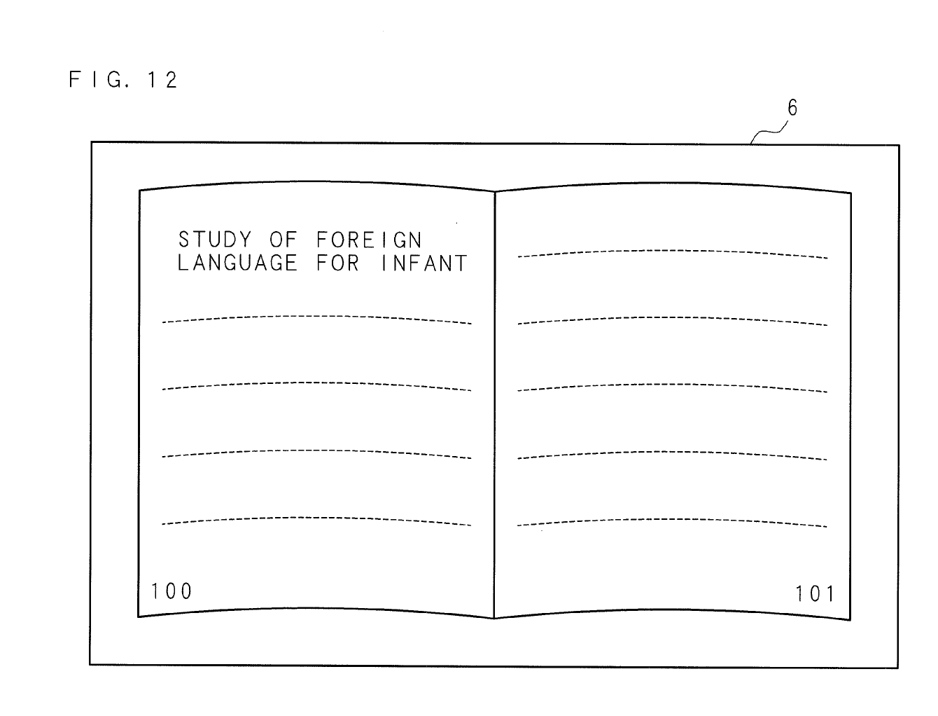

For example, suppose that the user selects an electronic book relating to Book Data 5 in the information management table 45 illustrated in FIG. 3. This electronic book is “Infant Education White Paper”, and, as illustrated in FIG. 12, the image of given pages (page 100 and page 101) of the electronic book is displayed in the display section 6. This electronic book has one supplement (“Supplement 5A”).

By monitoring the movement detection section 10, or based on the detection result of the movement detection section 10, the CPU 1 determines whether or not the operation of shaking the book data display device 100 in up and down directions was performed (step S305).

If determined that the operation of shaking the book data display device 100 in up and down directions was performed (step S305: YES), the CPU 1 determines, based on the detection result of the posture detection section 11, whether or not the display section 6 faces a downward direction (step S306).

If determined that the display section 6 does not face a downward direction (step S306: NO), the CPU 1 returns the processing to step S305. Or other process corresponding to the shaking operation performed in a state where the display section 6 does not face a downward direction is appropriately performed.

If determined that the display section 6 faces a downward direction (step S306: YES), the CPU 1 looks up the information management table 45 in FIG. 3 and obtains information indicating that the supplement to the selected electronic book is “Supplement 5A” and that displaying of the supplement is limited to only when the page (number) being displayed is 100.

Next, the CPU 1 determines whether or riot the page being displayed currently in the display section 6 is page 100 (step S307).

If determined that the page being displayed currently in the display section 6 is not page 100 (step S307: NO), the CPU 1 returns the processing to step S305.

On the other hand, as illustrated in FIG. 12, when page 100 and page 101 are being displayed, the CPU 1 determines that the page being currently displayed in the display section 6 is page 100 (step S307: YES), and instructs the display control section 7 to display' the image of “Supplement 5A”.

According to an instruction from the CPU 1, the display control section 7 retrieves supplement image data corresponding to “Supplement 5A” from the supplement data storage section 42 and displays the image of “Supplement 5A” based on the supplement image data in the display section 6 (step S308). Thereafter, the processing returns to step S305 again.

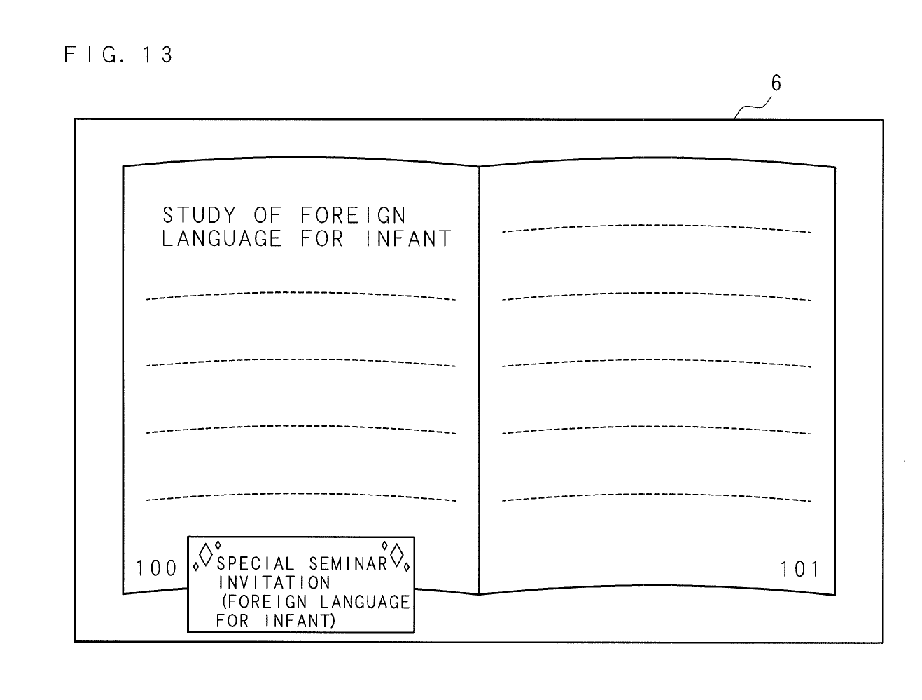

For example, when “Supplement 5A” is “Special Seminar Invitation”, as illustrated in FIG. 13, the supplement is displayed on page 100. The user can display the image of the supplement in an enlarged manner by touching the image and can show it at the entrance of the seminar.

On the other hand, if determined in step S305 that the operation of shaking the book data display device 100 in up and down directions was not performed (step S305: NO), the CPU 1 monitors the position receiving section 8 and determines, based on a signal from the position receiving section 8, whether or not the user performed the operation of touching the display screen of the display section 6 (step S309).

The subsequent processes in steps S309 to step S312 are the same as those in steps S108 to step S111 of Embodiment 1, and therefore detailed explanation thereof is omitted.

The same parts as in Embodiment 1 will be designated with the same reference numbers, and detailed explanation thereof is omitted.

Note that the present invention is not limited to those mentioned above. It is supposed, for example, that the user may select an electronic book relating to Book Data 4 in the information management table in FIG. 3. In the information management table 45, it is stated that the supplement to the electronic book is “Supplement 4A” and there is a further supplement for premium members.

Hence, in the case where the electronic book relating to Book Data 4 is selected, when the CPU 1 determines that a specific “shaking operation”, that is, shaking the book data display device 100 in up and down directions in the state where the display section 6 faces a downward direction, was performed, the display control section 7 displays the supplement (“Supplement 4A”) relating to the electronic book being displayed, and thereafter, when the CPU 1 determines that the specific “shaking” operation was performed again, the display control section 7 displays the supplement for premium members in place of, or together with, the supplement being displayed.

### Embodiment 4

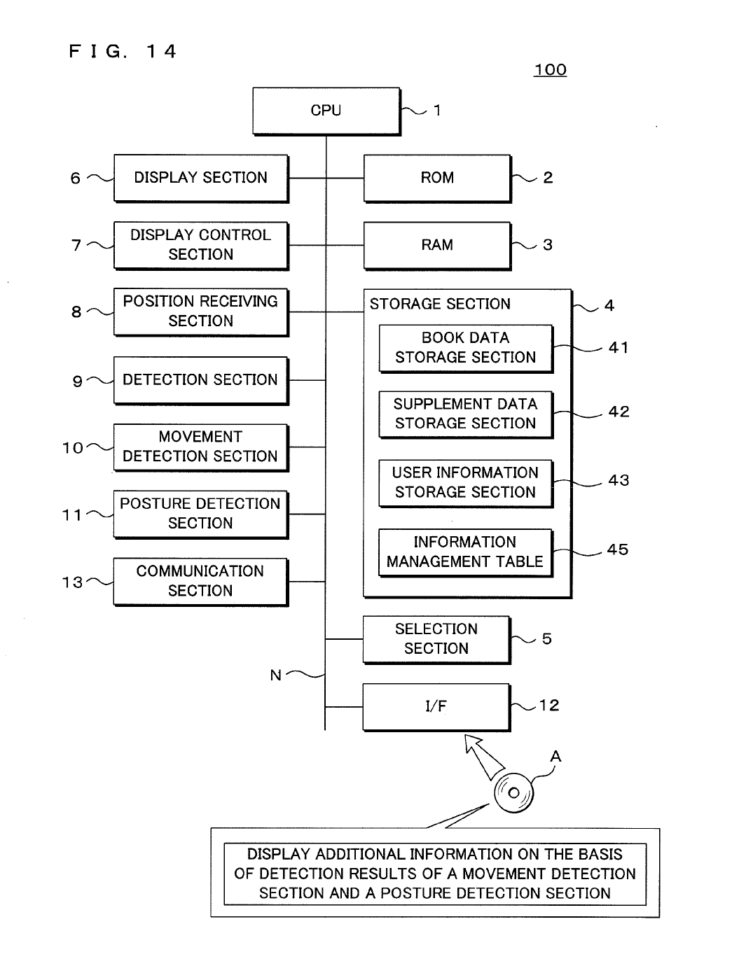

FIG. 14 is a functional block diagram illustrating an essential configuration of a book data display device 100 according to Embodiment 4 of the present invention. The book data display device 100 according to Embodiment 4 is configured to allow a computer program for performing operations to be provided in the form of a removable recording medium A, such as a CD-ROM, through an I/F 12. Further, the book data display device 100 of Embodiment 4 is configured to be capable of downloading the computer program from an external device (not shown) through a communication section 13. The content will be explained below.

The book data display device 100 of Embodiment 4 comprises an external (or internal) recording medium reading device (not shown), inserts into the recording medium reading device the removable recording medium A storing a program for displaying a supplement (additional information) on the basis of detection results of the movement detection section 10 and the posture detection section 11, and causes the CPU 1 to install the program into the ROM 2, for example. The program is loaded into the RAM 3 and executed. Hence, it functions as the book data display device 100 of Embodiments 1 to 3 of the present invention.

The recording medium may be a so-called program medium, or a medium carrying program codes in a fixed manner, such as tapes including a magnetic tape and a cassette tape, disks such as magnetic disks including a flexible disk and a hard disk, and optical disks including a CD-ROM, an MO, an MD, and a DVD, cards such as an IC card (including a memory card) and an optical card, or a semiconductor memory like a mask ROM, an EPROM, an EEPROM, and a flash ROM.

The recording medium may be a medium carrying program codes in a flowing manner like by downloading the program codes from a network through the communication section 13. In the case where the program is downloaded from a communication network in such a Manner, a program for downloading may be stored in advance in the main device, or installed from another recording medium. The present invention can also be implemented in the form of a computer data signal embedded in a carrier wave in which the program codes are embodied by an electronic transfer.

The same parts as in Embodiment 1 are designated with the same reference numbers, and detailed explanation thereof is omitted.

As this description may be embodied in several forms without departing from the spirit of essential characteristics thereof, the present embodiments are therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A display device, including a storage section storing content with additional information, and a display section for displaying an image relating to the content, the display device comprising:
a movement detection section for detecting a movement of the display device; and
a display control section for displaying the additional information in the display section on the basis of a detection result of the movement detection section.

2. The display device according to claim 1, further comprising a posture detection section for detecting a posture of the display device, wherein
the display control section displays the additional information on the basis of detection results of the movement detection section and the posture detection section.

3. The display device according to claim 1, wherein
the storage section stores a plurality of pieces of additional information, display conditions for each piece of additional information, and user information,
the display device further comprises a selection section for selecting a given piece of additional information on the basis of the display conditions for additional information and the user information, and
the display control section displays the additional information selected by the selection section.

4. The display device according to claim 1, wherein
the content is composed of a plurality of pages of images,
the storage section stores additional information in association with a specific page of the content, and
when the specific page is displayed in the display section, the display control section displays the corresponding additional information.

5. A display device, including a storage section storing content with additional information, and a display section for displaying an image relating to the content, the display device comprising:
movement detecting means for detecting a movement of the display device; and
displaying means for displaying the additional information in the display section on the basis of a detection result of the movement detecting means.

6. The display device according to claim 5, further comprising posture detecting means for detecting a posture of the display device, wherein
the displaying means displays the additional information on the basis of detection results of the movement detecting means and the posture detecting means.

7. The display device according to claim 5, wherein
the storage section stores a plurality of pieces of additional information, display conditions for each piece of additional information, and user information,
the display device further comprises selecting means for selecting a given piece of additional information on the basis of the display conditions for additional information and the user information, and
the displaying means displays the additional information selected by the selecting means.

8. The display device according to claim 5, wherein
the content is composed of a plurality of pages of images,
the storage section stores additional information in association with a specific page of the content, and
when the specific page is displayed in the display section, the displaying means displays the corresponding additional information.

9. A display method for displaying additional information with a display device, which includes a storage section storing content with additional information, a display section for displaying an image relating to the content, a movement detection section for detecting a movement of the display device, and a posture detection section for detecting a posture of the display device, the method comprising:
a step of detecting the movement and posture of the display device by the movement detection section and the posture detection section; and
a step of displaying the additional information in the display section on the basis of detection results of the movement detection section and the posture detection section.

10. A non-transitory computer-readable recording medium storing a computer program for causing a computer constituting a display device, which includes a storage section storing content with additional information, a display section for displaying an image relating to the content, a movement detection section for detecting a movement of the display device, and a posture detection section for detecting a posture of the display device, to display the additional information, said computer program comprising:
a step of causing the computer to perform detection of the movement and posture of the display device with the movement detection section and the posture detection section; and
a step of causing the computer to display the additional information in the display section on the basis of detection results of the movement detection section and the posture detection section.
